(19) United States
(12) Patent Application Publication
(10) Pub. No.: US 2026/0106258 A1
(43) Pub. Date: Apr. 16, 2026

(54) BATTERY MODULE AND BATTERY PACK INCLUDING THE SAME

(71) Applicant: SAMSUNG SDI CO., LTD., Yongin-si (KR)

(72) Inventor: Jihwan SEOL, Yongin-si (KR)

(21) Appl. No.: 19/174,079

(22) Filed: Apr. 9, 2025

(30) Foreign Application Priority Data
Oct. 11, 2024 (KR) 10-2024-0138530

(51) Int. Cl. H01M 10/653; H01M 10/613; H01M 10/6551; H01M 10/6555; H01M 10/6557; H01M 50/204; H01M 50/242; H01M 50/244

(52) U.S. Cl. CPC H01M 10/653; H01M 10/613; H01M 10/6551; H01M 10/6555; H01M 10/6557; H01M 50/242; H01M 50/244; H01M 50/204

(57) ABSTRACT

A battery module includes a plurality of battery cells, a cooling plate between a first battery cell and a second battery cell of the plurality of battery cells, the first battery cell and the second battery cell being arranged along a first direction, and the cooling plate extending along a second direction perpendicular to the first direction, a thermally conductive elastic member between the first battery cell and the cooling plate, the thermally conductive elastic member extending along the second direction and having a first surface in contact with a first surface of the first battery cell and a second surface, opposite to the first surface, in contact with a first surface of the cooling plate, and a module frame accommodating the plurality of battery cells, the cooling plate, and the thermally conductive elastic member.

### CROSS-REFERENCE TO RELATED APPLICATION

The present application claims priority to and the benefit of Korean Application No. 10-2024-0138530, filed on Oct. 11, 2024, in the Korean Intellectual Property Office, the entire disclosure of which is incorporated by reference herein.

### BACKGROUND

### 1. Field

Aspects of embodiments of the present disclosure relate to a battery module and a battery pack including the battery module.

### 2. Description of the Related Art

A secondary battery is a rechargeable battery that is designed to be discharged and recharged multiple times. Such secondary batteries are commonly used in various applications including electronic devices (e.g., smartphones, laptops, and tablets), electric vehicles (EVs), solar power generation, and emergency power supply systems (EPS). In particular, due to their high energy density and high charge/discharge efficiency, lithium-ion batteries are widely used as energy storage systems (ESS).

The above information disclosed in this Background section is for enhancement of understanding of the background of the present disclosure, and therefore, it may contain information that does not constitute related (or prior) art.

### SUMMARY

A battery module according to one or more embodiments of the present disclosure includes a plurality of battery cells; a cooling plate disposed between a first battery cell and a second battery cell arranged along a first direction among the plurality of battery cells, the cooling plate extending along a second direction perpendicular to the first direction; a thermally conductive elastic member disposed between the first battery cell and the cooling plate, the thermally conductive elastic member extending along the second direction and having a first surface in contact with a first surface of the first battery cell and a second surface, opposite to the first surface, in contact with a first surface of the cooling plate; and a module frame accommodating the plurality of battery cells, the cooling plate, and the thermally conductive elastic member.

According to one or more embodiments of the present disclosure, the thermally conductive elastic member may be configured to absorb expansion force generated during charging and discharging of the first battery cell.

According to one or more embodiments of the present disclosure, the thermally conductive elastic member may be configured to transfer heat generated by the first battery cell to the cooling plate.

According to one or more embodiments of the present disclosure, the thermally conductive elastic member may be configured to electrically insulate the first battery cell from the cooling plate.

According to one or more embodiments of the present disclosure, the thermally conductive elastic member may include silicone.

According to one or more embodiments of the present disclosure, the thermally conductive elastic member may be formed by mixing silicone resin with thermally conductive powder.

According to one or more embodiments of the present disclosure, the thermally conductive elastic member may be in the form of a sheet.

According to one or more embodiments of the present disclosure, the thermally conductive elastic member may be in the form of an adhesive so as to be applied to the cooling plate.

According to one or more embodiments of the present disclosure, the cooling plate may include at least one cooling channel through which coolant flows, the at least one cooling channel extending along the second direction.

According to one or more embodiments of the present disclosure, the battery module described above may further include a coolant supply device, and a coolant flow path connecting the coolant supply device to the at least one cooling channel of the cooling plate.

According to one or more embodiments of the present disclosure, each of the plurality of battery cells may include a pair of long sidewall portions facing each other while being spaced apart from each other, and a pair of short sidewall portions facing each other while being spaced apart from each other, each of the short sidewall portions being formed to have a smaller area than each of the long sidewall portions.

According to one or more embodiments of the present disclosure, the first battery cell and the second battery cell may be arranged along the first direction such that their long sidewall portions face each other with the cooling plate interposed therebetween.

According to one or more embodiments of the present disclosure, the plurality of battery cells may further include a third battery cell and a fourth battery cell, the first battery cell and the third battery cell may be arranged along the second direction such that their short sidewall portions face each other, and the second battery cell and the fourth battery cell may be arranged along the second direction such that their short sidewall portions face each other.

According to one or more embodiments of the present disclosure, the plurality of battery cells may include a third battery cell and a fourth battery cell. The first battery cell and the third battery cell may be arranged along the second direction, the second battery cell and the fourth battery cell may be arranged along the second direction, the cooling plate may be disposed between the third battery cell and the fourth battery cell, the thermally conductive elastic member may be disposed between the third battery cell and the cooling plate, and the first surface of the thermally conductive elastic member may be in contact with a first surface of the third battery cell.

A battery pack according to one or more embodiments of the present disclosure includes: a plurality of battery modules, and a battery management system (BMS) connected to the plurality of battery modules. Each of the plurality of battery modules includes a plurality of battery cells, and a cooling plate disposed between a first battery cell and a second battery cell arranged along a first direction among the plurality of battery cells, the cooling plate extending along a second direction perpendicular to the first direction. Each of the plurality of battery modules further includes a thermally conductive elastic member disposed between the first battery cell and the cooling plate, the thermally conductive elastic member extending along the second direction and having a first surface in contact with a first surface of the first battery cell and a second surface, opposite to the first surface, in contact with a first surface of the cooling plate, and a module frame accommodating the plurality of battery cells, the cooling plate, and the thermally conductive elastic member.

According to one or more embodiments of the present disclosure, the thermally conductive elastic member may be configured to electrically insulate the first battery cell from the cooling plate.

According to one or more embodiments of the present disclosure, the thermally conductive elastic member may include silicone.

According to one or more embodiments of the present disclosure, the thermally conductive elastic member may be formed by mixing silicone resin with thermally conductive powder.

According to one or more embodiments of the present disclosure, the cooling plate may include at least one cooling channel through which coolant flows, the at least one cooling channel extending along the second direction.

According to one or more embodiments of the present disclosure, the battery pack may further include a coolant supply device, and a coolant flow path connecting the coolant supply device to the at least one cooling channel of the cooling plate.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a perspective view of a battery module according to one or more embodiments of the present disclosure.

FIG. 2 illustrates a perspective view of a battery cell according to one or more embodiments of the present disclosure.

FIG. 3 illustrates a cross-sectional view of a battery cell according to one or more embodiments of the present disclosure.

FIG. 4 illustrates an exploded perspective view of a portion of a battery module according to one or more embodiments of the present disclosure.

FIG. 5 illustrates an enlarged cross-sectional view of a cooling plate according to one or more embodiments of the present disclosure.

FIGS. 6 and 7 illustrate plan views of a battery module according to one or more embodiments of the present disclosure.

FIG. 8 illustrates a block diagram of a configuration of a battery pack according to one or more embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

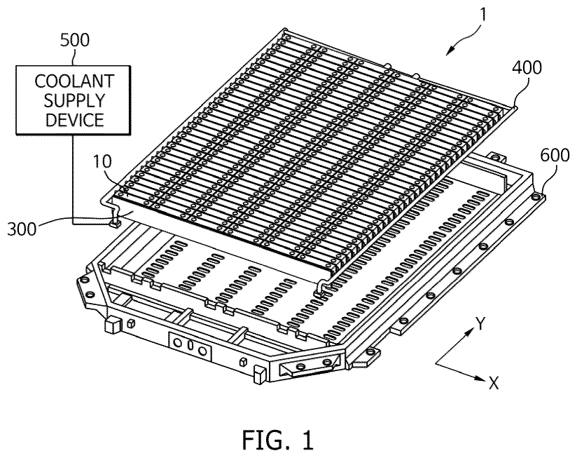

FIG. 1 illustrates a perspective view of a battery module 1 according to one or more embodiments of the present disclosure.

Referring to FIG. 1, the battery module 1 according to one or more embodiments of the present disclosure may include a plurality of battery cells 10 (e.g., a plurality of secondary batteries), a cooling plate 300, a coolant flow path 400, a coolant supply device 500, and a module frame 600.

In one or more embodiments, the battery module 1 may be referred to as a battery pack. For example, the battery module 1 may be incorporated into a vehicle or an energy storage system. In another example, the battery pack may include a plurality of such battery modules 1.

The battery module 1 may include the plurality of battery cells 10. In one or more embodiments, some of the plurality of battery cells 10 in the battery module 1 may be arranged in a second direction (e.g., the X-axis direction) such that their narrow sides (surfaces) face each other. For example, as shown in FIG. 1, six battery cells may be arranged in the second direction with their narrow sides facing each other. For example, multiple sets of six battery cells arranged in the second direction (e.g., the X-axis direction) may be further arranged in a first direction (e.g., the Y-axis direction).

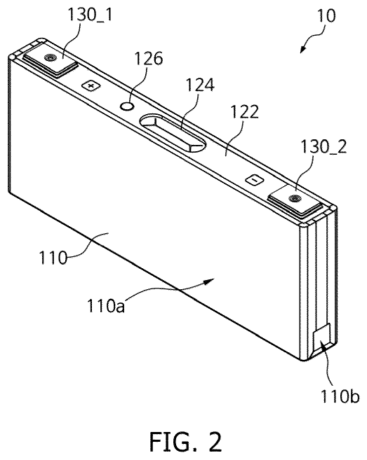

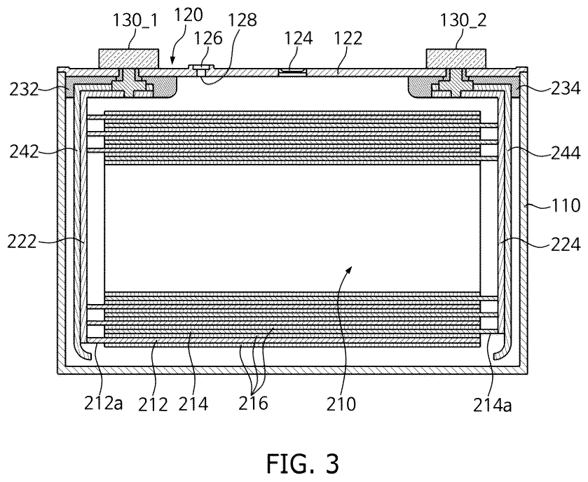

In one or more embodiments, each battery cell 10 may include a case, an electrode assembly accommodated inside the case along with an electrolyte, and a cap plate for sealing the case. However, a structure of each battery cell 10 may be suitably modified as required. Furthermore, the number and arrangement of the battery cells 10 in the battery module 1 may be appropriately changed as required. For example, the battery cell 10 may be implemented in various shapes, such as prismatic or cylindrical, depending on the intended use of the battery cell. In a case where the battery cell 10 is a prismatic cell, it may be implemented as a top terminal type and/or a side terminal type. The battery cell 10 will be described in detail with reference to FIGS. 2 and 3.

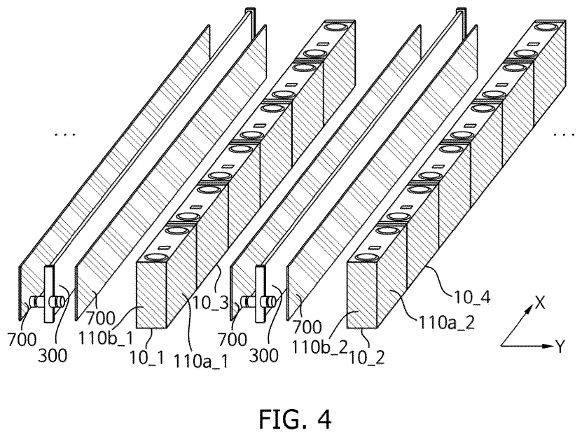

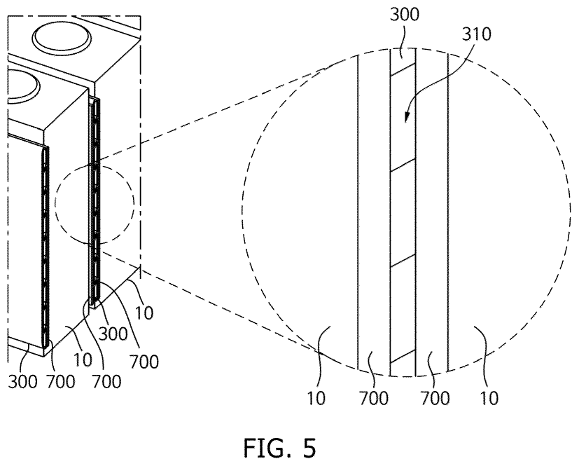

In one or more embodiments, the cooling plate 300 may be disposed between two battery cells 10 arranged along the first direction among the plurality of battery cells 10. For example, the cooling plate 300 may be positioned between adjacent battery cells 10 aligned in the Y-axis direction. In this configuration, the cooling plate 300 may be arranged to face a wide side (surface) of each battery cell 10. Accordingly, as the temperatures of the plurality of battery cells 10 increase, heat may be effectively transferred to the cooling plate 300, thereby lowering the temperatures of the plurality of battery cells 10. The cooling plate 300 will be described in detail with reference to FIGS. 4 and 5.

In one or more embodiments, the coolant flow path 400 may be configured to receive a coolant from the coolant supply device 500. Accordingly, a coolant capable of absorbing heat generated within the plurality of battery cells 10 may move along the coolant flow path 400. For example, the coolant flow path 400 may be formed to extend along a perimeter of the module frame 600 and supply the coolant to a plurality of cooling plates 300.

In one or more embodiments, the coolant flow path 400 may be configured to supply the coolant by being connected to at least one surface of each of the plurality of cooling plates 300. For example, the coolant flow path 400 may connect the coolant supply device 500 to at least one cooling channel of each of the plurality of cooling plates 300. Here, the supply and discharge of the coolant may be performed in a parallel manner or in a series manner. For example, in the parallel manner, the coolant flow path 400 may be connected to an additional coolant flow path 400 in a parallel such that the coolant is supplied collectively from the coolant flow path 400 to the plurality of cooling plates (i.e., to multiple cooling channels of multiple cooling plates) and the coolant discharged from the plurality of cooling plates flows through the additional coolant flow path 400. In another example, in the series manner, the coolant may be supplied from the coolant flow path 400 to one cooling plate (e.g., to one cooling channel of one cooling plate), and the coolant discharged therefrom may flow to an adjacent cooling plate.

In one or more embodiments, the coolant supply device 500 may control the circulation of the coolant supplied to the coolant flow path 400. For example, the coolant supply device 500 may control the amount and supply speed (e.g., supply rate) of the coolant provided to the coolant flow path 400. For example, referring to FIG. 1, the coolant supply device 500 may be installed adjacent to the outside of the module frame 600. In another example, the coolant supply device 500 may be installed inside the module frame 600.

In one or more embodiments, the module frame 600 may accommodate the plurality of battery cells 10, the cooling plate(s) 300, and the coolant flow path(s) 400. For example, a tray or a bottom plate may be provided under the battery cells 10 to support the battery cells 10 from the bottom. Additionally, a top plate may be arranged on the top of the module frame 600 to house a busbar holder, busbars, and a circuit board.

As described above, the plurality of battery cells 10 may be arranged to face the cooling plate 300. However, if swelling occurs in the battery cells 10, the battery cells 10 may expand and exert unintended pressure on the rigid surface of the cooling plate 300. Such expansion pressure may increase the pressure exerted on the battery cells 10 and, at the same time, may cause deformation of the cooling plate 300. In other words, the battery module 1, which includes the battery cells 10, may experience a reduction in lifespan due to these issues. Therefore, the battery module 1 and/or the battery pack according to one or more embodiments of the present disclosure may include a thermally conductive elastic member disposed between the battery cell 10 and the cooling plate 300. The thermally conductive elastic member will be described in detail with reference to FIGS. 4 and 5.

FIG. 2 illustrates a perspective view of the battery cell 10 according to one or more embodiments of the present disclosure, and FIG. 3 illustrates a cross-sectional view of the battery cell 10 according to one or more embodiments of the present disclosure.

Referring to FIGS. 2 and 3, the battery cell 10 according to one or more embodiments of the present disclosure may include at least one electrode assembly 210 wound with a separator 216 as an insulator between the positive electrode 212 and the negative electrode 214, a case 110 in which the electrode assembly 210 is received (or accommodated) therein, and a cap assembly 120 coupled to an opening of the case 110.

The battery cell 10 according to one or more embodiments of the present disclosure will now be described as an example of a prismatic lithium ion secondary battery. However, the present disclosure is not limited thereto, and suitable aspects, features and principles described herein may be applied to various other types of batteries, such as lithium polymer batteries and/or cylindrical batteries.

Each of the positive electrode 212 and the negative electrode 214 may include a current collector made of a thin metal foil having a coated portion on which an active material is coated and uncoated portions 212a, 214a on which an active material is not coated.

The positive electrode 212 and the negative electrode 214 are wound after interposing the separator 216, which is an insulator, therebetween. However, the present disclosure is not limited thereto, and the electrode assembly 210 may have a structure in which a positive electrode and a negative electrode, each made of a plurality of sheets, are alternately stacked with a separator interposed therebetween.

The case 110 may form the overall outer appearance of the secondary battery 10 and may be made of a conductive metal, such as aluminum, aluminum alloy, or nickel-plated steel. In addition, the case 110 may provide a space in which the electrode assembly 210 is accommodated.

For example, the case 110 may have one surface open and may form the bottom surface and side surfaces of the battery cell 10. The side surfaces of the case 110 may include a pair of long sidewall portions 110a that face each other while being spaced apart from each other, and a pair of short sidewall portions 110b that face each other while being spaced apart from each other. In this configuration, the area of each of the long sidewall portions 110a may be greater than the area of each of the short sidewall portions 110b.

The cap assembly 120 may include a cap plate 122 covering an opening in the case 110 and the cap plate 122 may be made of a conductive material. The positive and negative electrode terminals 130_1 and 130_2 electrically connected to the positive electrode 212 and the negative electrode 214 may protrude through the cap plate 122.

In addition, outer peripheral surfaces (e.g., circumferential surfaces) of upper pillars of the positive and negative electrode terminals 130_1 and 130_2 protruding outwardly from the cap plate 122 may have a rivet structure and may be riveted or welded to the cap plate 122.

In addition, the cap plate 122 may be made of a thin plate and may be coupled to the opening in the case 110, and an electrolyte injection port 128 into which a sealing stopper 126 may be installed may be located (e.g., formed) in the cap plate 122, and a vent portion 124 having a notch may be installed.

The positive and negative electrode terminals 130_1 and 130_2 may be electrically connected to current collectors including first and second current collectors 222 and 224 (hereinafter referred to as positive and negative current collectors) by being bonded or coupled (e.g., by welding) to the positive uncoated portion 212a and the negative uncoated portion 214a, respectively.

For example, the positive and negative electrode terminals 130_1 and 130_2 may be coupled by welding to the positive and negative current collectors 222 and 224, respectively. However, the present disclosure is not limited thereto, and the positive and negative electrode terminals 130_1 and 130_2 and the positive and negative electrode current collectors 222 and 224 may be integrally formed in one or more embodiments.

In addition, an insulation member may be installed between the electrode assembly 210 and the cap plate 122. The insulation member may include first and second lower insulation members 232 and 234, and each of the first and second lower insulation members 232 and 234 may also have a portion located between the electrode assembly 210 and the cap plate 122.

In addition, according to one or more embodiments of the present disclosure, one end of a separation member may face one side of the electrode assembly 210 and may be installed between the insulation member and the positive or negative electrode terminals 130_1 and 130_2. In one or more embodiments, the separation member may include first and second separation members 242 and 244.

In such an embodiment, first ends of the first and second separation members 242 and 244 installed to face one side of the electrode assembly 210 may be respectively installed between the first and second lower insulation members 232 and 234 and the positive and negative electrode terminals 130_1 and 130_2.

Accordingly, the positive and negative electrode terminals 130_1 and 130_2, which may be coupled by welding to the positive and negative electrode current collectors 222 and 224, may be coupled to first ends of the first and second lower insulation members 232 and 234 and the first and second separation members 242 and 244.

In some examples, the positive and negative electrode terminals 130_1 and 130_2 may be positioned on a side surface on the left side and a side surface on the right side of the electrode assembly, respectively, or alternatively, they may be positioned on the same surface in a single direction. For clarity, the terms “left” and “right” are described for convenience of explanation based on the battery cell 10 shown in FIG. 2. However, the positions may vary depending on the orientation of the secondary battery when rotated left and right or up and down.

Additionally, the battery cell 10 may be a lithium battery cell, a sodium battery cell, or the like. However, the battery cell 10 may include all types of batteries capable of repeatedly supplying electricity through charging and discharging cycles. In one or more embodiments, in a case where the battery cell 10 is the lithium battery cell, the battery cell 10 may be used in electric vehicles (EVs) due to its excellent lifespan characteristics and high-rate capability. For example, the lithium battery cell may be used in hybrid vehicles such as plug-in hybrid electric vehicles (PHEVs). Furthermore, the lithium battery cell may be applied in fields requiring substantial power storage capacity. For instance, the lithium battery cell may be used in electric bicycles, power tools, and energy storage systems (ESS).

FIG. 4 illustrates an exploded perspective view of a portion of the battery module 1 according to one or more embodiments of the present disclosure.

Referring to FIG. 4, the cooling plate 300 may be disposed between a first battery cell 10_1 and a second battery cell 10_2. Here, the first battery cell 10_1 and the second battery cell 10_2 may be arranged along the first direction (e.g., adjacent to each other along the Y-axis direction). For example, the first battery cell 10_1 and the second battery cell 10_2 may be arranged along the first direction such that the long sidewall portions 110a of the first battery cell 10_1 and the second battery cell 10_2 are positioned to face each other with the cooling plate 300 interposed therebetween. In this arrangement, the cooling plate 300 may extend in the second direction (e.g., in the X-axis direction), perpendicular to the first direction (e.g., the Y-axis direction). For instance, as shown in FIG. 4, the cooling plate 300 may be disposed between the first battery cell 10_1 and the second battery cell 10_2, which are arranged along the Y-axis direction. Additionally, the cooling plate 300 may extend along the X-axis direction.

In one or more embodiments, the plurality of battery cells may additionally include a third battery cell 10_3 and a fourth battery cell 10_4. For example, the first battery cell 10_1 and the third battery cell 10_3 may be arranged along the second direction (e.g., adjacent to each other along the X-axis direction), such that the short sidewall portions 110b_1 of the first battery cell 10_1 and the third battery cell 10_3 are positioned to face each other. Similarly, the second battery cell 10_2 and the fourth battery cell 10_4 may also be arranged along the second direction (e.g., the X-axis direction) such that the short sidewall portions 110b_2 of the second battery cell 10_2 and the fourth battery cell 10_4 are positioned to face each other. In this arrangement, the cooling plate 300 may be disposed between the third battery cell 10_3 and the fourth battery cell 10_4. For example, referring to FIG. 4, the cooling plate 300 may extend continuously in the second direction (e.g., the X-axis direction) along an entirety of each row of adjacent battery cells 10.

In one or more embodiments, a thermally conductive elastic member 700 may extend in the second direction, similar to the cooling plate 300 (e.g., the thermally conductive elastic member 700 may extend continuously in parallel to the cooling plate 300 and along an entirety of each row of adjacent battery cells 10). For example, as shown in FIG. 4, the thermally conductive elastic member 700 may be disposed between the first battery cell 10_1 and the cooling plate 300, and the thermally conductive elastic member 700 may extend in the X-axis direction. Here, one surface of the thermally conductive elastic member 700 may be in contact (e.g., direct contact) with one surface of the first battery cell 10_1 while the other surface (the opposite surface) of the thermally conductive elastic member 700 may be in contact (e.g., direct contact) with one surface of the cooling plate 300. Accordingly, the first battery cell 10_1, the thermally conductive elastic member 700, the cooling plate 300, another thermally conductive elastic member 700, and the second battery cell 10_2 may be sequentially arranged in the first direction (e.g., in the Y-axis direction). In this configuration, the thermally conductive elastic member 700 may be configured to transfer heat generated by the battery cell 10 to the cooling plate 300. Additionally, the thermally conductive elastic member 700 may be disposed between the third battery cell 10_3 and the cooling plate 300. For example, one surface of the thermally conductive elastic member 700 may be in contact with one surface of the third battery cell 10_3. For example, the relevant surface of the third battery cell 10_3 may be the long sidewall portion 110a_1 of the third battery cell 10_3. The alignment of the battery cell 10, the thermally conductive elastic member 700, and the cooling plate 300 may vary depending on the arrangement of the battery cells 10.

In one or more embodiments, the thermally conductive elastic member 700 may be configured to absorb expansion force generated during the charging and discharging of the first battery cell 10_1. Further, the thermally conductive elastic member 700 may be configured to electrically insulate the first battery cell 10_1 from the cooling plate 300. The thermally conductive elastic member 700 may include a material having both elasticity and insulation properties. For example, the thermally conductive elastic member 700 may include silicone. In one example, the thermally conductive elastic member 700 may be formed by mixing silicone resin and thermally conductive powder. The thermally conductive elastic member 700 has elasticity, and thus the thermally conductive elastic member 700 may absorb the expansion force of the battery cell 10. In other words, even when the battery cell 10 expands, the thermally conductive elastic member 700 may reduce the pressure exerted on the battery cell 10. Further, because the thermally conductive elastic member 700 has elasticity, the thermally conductive elastic member 700 may prevent deformation of the cooling plate 300 caused by the expansion of the battery cell 10. Furthermore, the thermally conductive elastic member 700 has thermal conductivity, and thus the thermally conductive elastic member 700 may effectively transfer heat generated by the battery cell 10 to the cooling plate 300. For example, the thermal conductivity of the thermally conductive elastic member 700 may range from 0.13 W/mK to 2.5 W/mK.

In one or more embodiments, the thermally conductive elastic member 700 may be installed in various forms within the battery module 1. For example, the thermally conductive elastic member 700 may be formed as an ultra-thin sheet or a pad with a predetermined thickness. In another example, the thermally conductive elastic member may be in the form of an adhesive so as to be applied to the cooling plate 300. For example, the thickness of the thermally conductive elastic member 700 may range from 0.05 mm to 3 mm. Battery cells 10 positioned closer to the center of the battery module 1 are more likely to experience greater pressure due to swelling. Accordingly, the thermally conductive elastic member 700 may be configured to have higher elasticity when positioned closer to the center of the battery module 1.

As described above, according to one or more embodiments of the present disclosure, the thermally conductive elastic member 700 may minimize damage caused by direct contact between the battery cell 10 and the cooling plate 300 during the swelling of the battery cell 10. In other words, this configuration improves the stability and extends lifespan of the battery cell 10.

Moreover, according to one or more embodiments of the present disclosure, the thermally conductive elastic member 700 is configured to quickly transfer heat generated from the battery cell 10 to the cooling plate 300 while electrically insulating the battery cell 10 from the cooling plate 300. In other words, this configuration enhances the stability and prolongs the lifespan of the battery module 1.

FIG. 5 illustrates an enlarged cross-sectional view of the cooling plate 330 according to one or more embodiments of the present disclosure.

Referring to FIG. 5, the cooling plate 300 may include at least one cooling channel 310 extending in the second direction to allow the coolant to flow therethrough. The cooling channel 310 may receive the coolant from the coolant flow path of the battery module 1. For example, the outer structure of the cooling plate 300 may be formed of heat-conducting plates, and at least one cooling channel 310 may be formed between the heat-conducting plates. Here, the heat-conducting plate may include an aluminum matrix. For example, the cooling channel 310 may be formed of metal and mounted to be fixedly secured within the cooling plate 300. In another example, the cooling channel 310 may be made of any material and formed in any shape that ensures sufficient and uniform cooling of each battery cell 10.

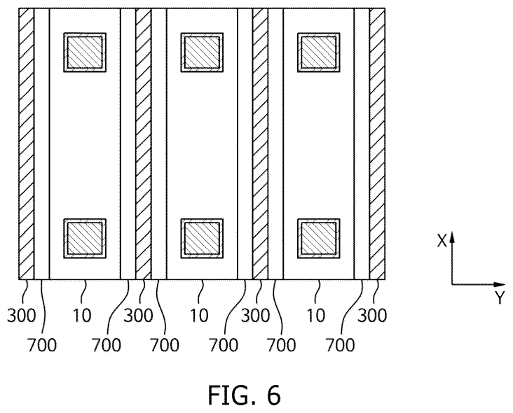

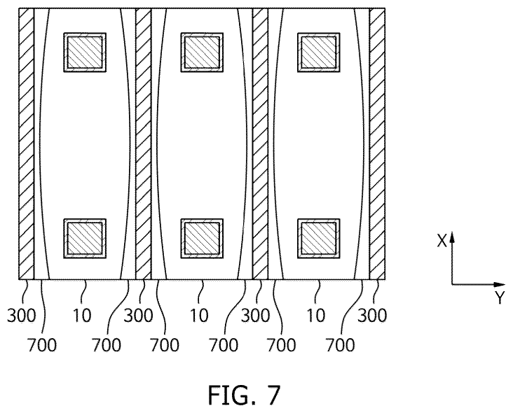

FIGS. 6 and 7 illustrate plan views of a battery module according to one or more embodiments of the present disclosure.

Referring to FIG. 6, the cooling plate 300 may be disposed between two adjacent battery cells of a plurality of battery cells 10. Here, the plurality of battery cells 10 may be arranged along the first direction, which is the Y-axis direction. In this configuration, the cooling plate 300 may extend along the second direction, which is the X-axis direction, perpendicular to the first direction. Similarly, the thermally conductive elastic member 700 may also extend along the second direction (the X-axis direction) in a manner similar to the cooling plate 300.

In one or more embodiments, the thermally conductive elastic member 700 may be disposed between the first battery cell 10_1 and the cooling plate 300. For example, one surface of the thermally conductive elastic member 700 may be in contact with one surface of the battery cell 10. Further, the other surface (the opposite surface) of the thermally conductive elastic member 700 may be in contact with one surface of the cooling plate 300. Accordingly, as shown in FIG. 6, the battery cell 10, the thermally conductive elastic member 700, the cooling plate 300, another thermally conductive elastic member 700, and another battery cell 10 may be sequentially arranged. In the event that the battery cell 10 experiences swelling, the thermally conductive elastic member 700 may serve to absorb the impact between the battery cell 10 and the cooling plate 300.

In one or more embodiments, the thermally conductive elastic member 700 may be configured to electrically insulate the battery cell 10 from the cooling plate 300. Additionally, due to its thermal conductivity, the thermally conductive elastic member 700 can effectively transfer heat generated by the battery cell 10 to the cooling plate 300.

Referring to FIG. 7, In the event that the battery cell 10 experiences swelling, the central portion of the battery cell 10 may expand toward the cooling plate 300 to form a convex shape. Such deformation of the battery cell 10 may cause the thermally conductive elastic member 700 to deform as well. At this time, the thermally conductive elastic member 700 has elasticity, so that the thermally conductive elastic member 700 can absorb the expansion force of the battery cell 10. In other words, the thermally conductive elastic member 700 can reduce the pressure exerted on the battery cell 10 even when the battery cell 10 expands. Additionally, because the thermally conductive elastic member 700 has elasticity, the thermally conductive elastic member 700 can prevent deformation of the cooling plate 300 caused by the expansion of the battery cell 10. For example, the central portion of the battery cell 10 may bend inward to form a concave shape. In this case, due to its elasticity, the thermally conductive elastic member 700 can easily deform in response to the deformation of the battery cell 10.

As described above, according to one or more embodiments of the present disclosure, the thermally conductive elastic member 700 can minimize damage caused by direct contact between the battery cell 10 and the cooling plate 300 during the swelling of the battery cell 10. In other words, this configuration improves the stability and extends lifespan of the battery cell 10.

For example, as illustrated in FIGS. 6 and 7, the cooling plate 300 may be disposed between every two adjacent battery cells of all the battery cells 10 arranged in the first direction. In another example, the cooling plate 300 may be omitted between some of the battery cells 10 arranged in the first direction.

For example, as illustrated in FIGS. 6 and 7, the thermally conductive elastic members 700 may be disposed on both side surfaces (opposite side surfaces) of the cooling plate 300. In another example, the thermally conductive elastic member 700 may be disposed only on one side surface of the cooling plate 300, or in some cases, some cooling plates 300 may have no thermally conductive elastic member 700 on both side surface thereof.

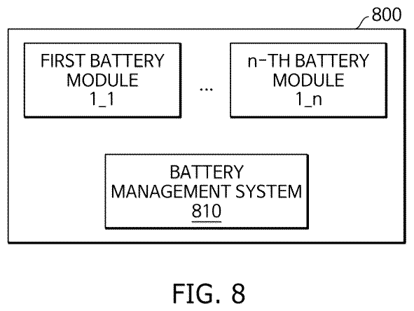

FIG. 8 illustrates a block diagram of a configuration of a battery pack 800 according to one or more embodiments of the present disclosure.

Referring to FIG. 8, the battery pack 800 may include a plurality of battery modules 1_1 to 1-n connected in series and/or in parallel, and a battery management system (BMS) 810. The battery management system 810 may be configured to transmit and receive information to and from the plurality of battery modules 1_1 to 1-n using wired and/or wireless communication.

In one or more embodiments, to facilitate efficient management of the battery modules, the battery management system (BMS) 810 may be configured to receive state information of the battery cells and/or information related to defects in a battery management module from each of the battery modules 1_1 to 1-n. To this end, each of the battery modules 1_1 to 1-n may include the battery management module. For example, each of the battery modules 1_1 to 1-n may transmit the state information of the battery cells therein and/or information related to defects in the corresponding battery management module to the battery management system 810. Additionally, each of the battery modules 1_1 to 1-n may communicate with other battery management modules by using wired or wireless communication to transmit and receive the state information of the battery cells, information related to defects in the corresponding battery management module, and instructions received from the battery management system 810.

In one or more embodiments, the battery management system (BMS) 810 may be configured to monitor the states of a plurality of battery modules 1_1 to 1-n. Further, each of the plurality of battery modules may be configured to monitor the states of the battery cells included therein. For example, each of the plurality of battery modules may obtain data related to the states of the battery cells through a plurality of cables connected to a plurality of sensors that measure at least one of the current, the voltage, or the temperature of each of at least some of the battery cells.

In one or more embodiments, each of the plurality of battery modules 1_1 to 1-n may monitor the states of the battery cells included therein based on the state information such as the voltages, the currents, and the temperatures of the battery cells. For example, each of the plurality of battery modules 1_1 to 1-n may determine, by a microcontroller unit (not shown), whether the battery cells are in an overvoltage or undervoltage state based on at least one piece of state information, such as the voltage, the current, or the temperature of each of the battery cells. In another example, each of the plurality of battery modules 1_1 to 1-n may detect voltage differences among the battery cells based on at least one piece of state information, such as the voltage, the current, or the temperature of each of the battery cells. Additionally, each of the plurality of battery modules 1_1 to 1-n may, upon detecting the voltage differences among the battery cells, adjust the voltage differences using a balancing circuit (not shown) to balance the voltage among the battery cells.

In one or more embodiments, each of the plurality of battery modules 1_1 to 1-n may include a plurality of sensors configured to measure at least one of the voltage or the temperature of each of at least some of the battery cells, an analog front end (AFE) circuit connected to the plurality of sensors through a plurality of cables, and a wired or wireless communication module connected to the AFE circuit and configured to communicate with external devices. In this configuration, the plurality of battery modules 1_1 to 1-n may communicate with the battery management system 810 and/or other battery modules using the wired and/or wireless communication module.

Each of the plurality of the battery modules 1_1 to 1-n shown in FIG. 8 may correspond to the battery module 1 shown in FIG. 1.

In the illustrated example of FIG. 8, the battery management system 810 and the plurality of battery modules 1_1 to 1-n are separately provided. However, the present disclosure is not limited thereto, and at least one of the plurality of battery modules 1_1 to 1-n may include the battery management system 810.

By way of summation and review, the secondary battery may experience swelling during operation due to various reasons including chemical reactions within the secondary battery, which may lead to an increase in internal pressure of the secondary battery. Such swelling may lead to rupture of the secondary battery or damage to a housing accommodating the secondary battery, thereby degrading the stability and lifespan of the secondary battery.

In contrast, embodiments of the present disclosure provide a battery module and a battery pack including the battery module, which include a thermally conductive elastic member between the battery cell and the cooling plate. Therefore, the thermally conductive elastic member can minimize damage caused by the contact between the battery cell and the cooling plate during the swelling of the battery cell.

According to one or more embodiments of the present disclosure, the thermally conductive elastic member can efficiently transfer heat generated from the battery cell to the cooling plate while electrically insulating the battery cell from the cooling plate. Therefore, the stability and lifespan of the battery module can be improved.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated.

Accordingly, it will be understood by those of skill in the art that various changes in form and details may be made without departing from the spirit and scope of the present invention as set forth in the following claims.

What is claimed is:

1. A battery module, comprising:
a plurality of battery cells;
a cooling plate between a first battery cell and a second battery cell of the plurality of battery cells, the first battery cell and the second battery cell being arranged along a first direction, and the cooling plate extending along a second direction perpendicular to the first direction;
a thermally conductive elastic member between the first battery cell and the cooling plate, the thermally conductive elastic member extending along the second direction and having a first surface in contact with a first surface of the first battery cell and a second surface, opposite to the first surface, in contact with a first surface of the cooling plate; and
a module frame accommodating the plurality of battery cells, the cooling plate, and the thermally conductive elastic member.

2. The battery module as claimed in claim 1, wherein the thermally conductive elastic member is configured to absorb expansion force generated during charging and discharging of the first battery cell.

3. The battery module as claimed in claim 1, wherein the thermally conductive elastic member is configured to transfer heat generated by the first battery cell to the cooling plate.

4. The battery module as claimed in claim 1, wherein the thermally conductive elastic member is configured to electrically insulate the first battery cell from the cooling plate.

5. The battery module as claimed in claim 1, wherein the thermally conductive elastic member includes silicone.

6. The battery module as claimed in claim 5, wherein the thermally conductive elastic member includes a silicone resin with thermally conductive powder.

7. The battery module as claimed in claim 1, wherein the thermally conductive elastic member is in a form of a sheet.

8. The battery module as claimed in claim 1, wherein the thermally conductive elastic member is in a form of an adhesive on the cooling plate.

9. The battery module as claimed in claim 1, wherein the cooling plate includes at least one cooling channel through which coolant flows, the at least one cooling channel extending along the second direction.

10. The battery module as claimed in claim 9, further comprising:
a coolant supply device; and
a coolant flow path connecting the coolant supply device to the at least one cooling channel of the cooling plate.

11. The battery module as claimed in claim 1, wherein each of the plurality of battery cells includes:
a pair of long sidewall portions facing each other while being spaced apart from each other; and
a pair of short sidewall portions facing each other while being spaced apart from each other, each of the short sidewall portions having a smaller area than each of the long sidewall portions.

12. The battery module as claimed in claim 11, wherein the first battery cell and the second battery cell are arranged along the first direction such that their long sidewall portions face each other with the cooling plate interposed therebetween.

13. The battery module as claimed in claim 11, wherein:
the plurality of battery cells further include a third battery cell and a fourth battery cell,
the first battery cell and the third battery cell are arranged along the second direction such that their short sidewall portions face each other, and
the second battery cell and the fourth battery cell are arranged along the second direction such that their short sidewall portions face each other.

14. The battery module as claimed in claim 1, wherein:
the plurality of battery cells include a third battery cell and a fourth battery cell,
the first battery cell and the third battery cell are arranged along the second direction,
the second battery cell and the fourth battery cell are arranged along the second direction,
the cooling plate is disposed between the third battery cell and the fourth battery cell,
the thermally conductive elastic member is disposed between the third battery cell and the cooling plate, and
the first surface of the thermally conductive elastic member is in contact with a first surface of the third battery cell.

15. A battery pack, comprising:
a plurality of battery modules; and
a battery management system connected to the plurality of battery modules, each of the plurality of battery modules including:
a plurality of battery cells,
a cooling plate between a first battery cell and a second battery cell arranged along a first direction among the plurality of battery cells, the cooling plate extending along a second direction perpendicular to the first direction,
a thermally conductive elastic member between the first battery cell and the cooling plate, the thermally conductive elastic member extending along the second direction and having a first surface in contact with a first surface of the first battery cell and a second surface, opposite to the first surface, in contact with a first surface of the cooling plate, and
a module frame accommodating the plurality of battery cells, the cooling plate, and the thermally conductive elastic member.

16. The battery pack as claimed in claim 15, wherein the thermally conductive elastic member is configured to electrically insulate the first battery cell from the cooling plate.

17. The battery pack as claimed in claim 15, wherein the thermally conductive elastic member includes silicone.

18. The battery pack as claimed in claim 15, wherein the thermally conductive elastic member includes a silicone resin with thermally conductive powder.

19. The battery pack as claimed in claim 15, wherein the cooling plate includes at least one cooling channel through which coolant flows, the at least one cooling channel extending along the second direction.

20. The battery pack as claimed in claim 19, further comprising:
a coolant supply device; and
a coolant flow path connecting the coolant supply device to the at least one cooling channel of the cooling plate.
